(19) United States
(12) Patent Application Publication
(10) Pub. No.: US 2003/0123636 A1
(43) Pub. Date: Jul. 3, 2003

(54) Method of routing telecommunications and data traffic

(76) Inventor: Tim A. Bigelow, Phoenix, AZ (US)

Correspondence Address: ELLIS & VENABLE, PC, 101 NORTH FIRST AVE., SUITE 1875, PHOENIX, AZ, 85003, US

(21) Appl. No.: 10/368,088

(22) Filed: Feb. 18, 2003

Related U.S. Application Data
(63) Continuation of application No. 09/426,104, filed on Oct. 22, 1999.

(51) Int. Cl. H04M 7/00

(52) U.S. Cl. 379/220.01

(57) ABSTRACT

The present invention enables a person to obtain a single telephone number that may be used to receive incoming telephone calls from anywhere in the world and route them to one or more telephone numbers anywhere in the world. The process of routing the incoming calls to a desired location is accomplished by the enabling the individual to remotely program a remote computer by accessing a software interface through the Internet.

This application is a Continued Prosecution Application pursuant to 37 C.F.R. §1.53(d) of U.S. patent application Ser. No. 09/426,104 filed on Oct. 22, 1999.

### FIELD OF THE INVENTION

The present invention relates to the field of telecommunications. More specifically, the present invention relates to routing incoming wired or wireless telephone calls to a desired location that may be determined and programmed by an end user.

### BACKGROUND

It is well known that with the advent of our mobile society, a person may receive telephone calls at various telephone numbers and locations. The person may have one or more telephone numbers at home, one or more telephone numbers at work, a wireless telephone, or other locations where the person may wish to receive telephone calls. A problem associated with having multiple numbers and locations where the person may receive telephone calls is that it becomes very difficult to locate the person at any given time unless it is known both where the person is located, and the telephone number where they are located. The more telephone numbers and locations, the more difficult it becomes for callers to reach the person.

In the past, if a person wished to receive telephone calls at various locations, few options existed. For example, the person could employ a call forwarding system that can be programmed at an originating telephone number to direct the call to a specific telephone or location. The drawbacks to this method are many. The person usually must program the call-forwarding feature on a telephone at the physical location of the originating number. The forwarding of calls will continue until the feature is manually reset on the same telephone. Furthermore, call forwarding is usually limited to a single forwarding telephone number. It would be extremely cumbersome to continually reprogram a telephone to direct calls to the person if he or she travels frequently throughout the day, or travels long distances.

Alternatively, the person could hire a personal receptionist that would receive incoming calls. The receptionist could direct the calls to the desired location manually, or the receptionist could inform the caller of the telephone number and location of the person to whom they are trying to reach. This also is particularly cumbersome due to the expense of the receptionist, and the need to maintain and have knowledge of the person's schedule, telephone numbers, and locations where the person will be during a given day.

The present invention addresses all of these issues by enabling a person to utilize a system whereby the individual may access the Internet to register for a single local telephone number that may route his or her incoming telephone calls to any telephone number in any location in the world. Calls made to a single telephone number can be routed to the person's home, office, cell, pager etc. The person can request, and be immediately issued, a distinct local telephone number by accessing a given Internet address. Once the person registers for, and is issued the telephone number, the number is available to receive incoming telephone calls. Subsequently, the person may utilize a simple programmable software interface accessible via the Internet to route calls made to the issued number to one or more local or long distance telephone numbers.

This unique system is accomplished by connecting computer equipment and software to a local telephone company's Central Office switch that in turn connects directly to the Internet. The equipment enables a person to program a database in the equipment through the programmable software interface via the Internet. The person may program locations and telephone numbers where he or she may be reached. When an incoming call is made to the telephone number chosen by the person, the call is directed to the computer equipment. The computer accesses the database for locations and telephone numbers where the call may be directed. If more than one location and telephone number has been programmed by the person, the computer requests that the caller, through a voice menu of options, select a location where they would like to reach the person. The caller then makes the choice by entering the number on the telephone keypad and the computer directs the Central Office switch to reroute the caller's traffic to the telephone number where the person is located.

The entire process of both issuing new telephone numbers and of routing the telephone calls is transparent to the telephone company. Because the person utilizes a simple software interface on the Internet for obtaining a new number, no longer will it be necessary to wait days to have technicians from the telephone company physically connect switches or equipment.

Additionally, the de-regulation of the telecommunications industry has enabled Competitive Local Exchange Carriers (CLECs) to offer telephone service through the Incumbent Local Exchange Carrier (ILEC) switches. These CLECs receive revenues when traffic is directed through their carrier switches. Initially, when these carrier switches are installed, they are drastically under-utilized. The present invention would allow increased traffic on the under-utilized switch thus increasing their traffic associated with this traffic. It also allows the telephone companies to add additional capacity to their already existing capacity.

In the past, CLECs have typically obtained new customers by making sales calls to the customers of the ILEC. CLECs have the capability to offer these new prospects, discounts off of their current local telephone bill. Unfortunately, this benefit has a limited value in the long-term. Discounts off a local telephone bill can only generate modest savings since the local charges are still controlled by the government. There are tariff rates that all phone companies must abide by which tends to put most phone companies, especially other CLECs, on an even playing field.

The present invention enables CLECs to obtain customers for their switch. Taking advantage of excess installed switch capacity, CLECs can incorporate the present invention that will allow users of the present invention to route phone traffic though the CLEC's switch. By routing this phone traffic, the users of the present invention are also new customers of the CLEC. The CLEC benefits from the additional revenues generated from that traffic just as if they were one of their standard customers.

The revenues generated from additional traffic on a CLECs switch come from originating and terminating toll (long distance) calls. A sizable percentage of every long distance call, whether it originates from the CLECs switch or terminates to a customer at the CLECs switch is paid from the long-distance company carrying the call to the CLEC. This constitutes a major source of revenue for the CLEC.

The usage of the excess switch capacity has multiple advantages for the CLEC. First, a CLEC can obtain more customers with a smaller sales staff. Since the present invention handles obtaining customers and downloads these customers to the equipment at the CLECs site, new customer interaction is virtually eliminated.

Secondly, a CLEC can support more customers with a smaller support staff. Again, since the entire customer interaction process (changes, modifications to service, etc.) is handled by though an Internet web site, fewer support people are needed by the CLEC.

Lastly, the present invention allows potential customers to use the present invention without changing their local service provider or making any long-term commitments. This allows the customers to become more familiar with the CLEC and increases the chance that the targeted potential customer will become a standard customer of the CLEC. This creates a very powerful sales tool for the CLECs sales staff and significantly increases their competitive advantage in the marketplace.

Additional features to the system include the following:

Internet-based call routing that would enable a person to route calls using the Internet interface to modify where the call is routed to upon selecting a given menu option during a telephone call.

An automatic greeting construction that enables a person to create custom greetings using selections from the software interface via the Internet. This feature would alleviate the person from having to record their own greeting.

An automatic telephone number selection system that enables a person to select his or her own number from a list of available numbers when signing up for the service.

An automated call router that enables a person to forward calls directly to a specific location. This would be accomplished by entering the person's schedule and telephone number information into the software interface via the Internet or a similar personal information manager such as Microsoft Outlook™.

An Internet-based call history log that enables a person to access through the Internet a history of times and telephone numbers that contacted the person.

A programmable alarm that enables a person to program the Internet-based schedule or personal information manager to automatically call a specific telephone number associated with the alarm that will play a custom message designed to remind the person of an event.

Location ringing that enables a person to automatically route calls to a phone number that is nearest to the person's current location.

There are a few systems known in the prior art that have similar Internet-based forwarding systems. A system located on the Internet at “efax.com” consists of a method of transmitting facsimile messages that enables a user to register for a telephone number that individuals may call to transmit facsimiles directly to the user. The facsimile is received in electronic form and stored on the Internet and subsequently forwarded to the user's email account as an attachment file in a standard email message. This system, however, does not disclose the ability to route voice messages, nor does it disclose a routing method and added features that are similar to the present invention.

Similar systems located on the Internet include “jfax.com” and “onebox.com.”These systems receive a fax or voice message, convert it into an email message and send it directly to the recipient's email program. If the recipient is away from his or her computer, the recipient may dial a toll-free number to check for voice messages, faxes and emails that have arrived. Again, this system, however, does not disclose the ability to route voice messages, nor does it disclose a routing method and added features that are similar to the present invention.

Another similar system is available at “progressive.net.” It utilizes a very complex system that is based upon voice recognition. It does not disclose any features that enable a caller to have control over where and to what telephone number he or she may reach the end user.

None of these systems address the ability route voice messages and give a user access and control over the system that are similar to the present invention.

### SUMMARY OF THE INVENTION

It is an object of the present invention to provide a system whereby a telephone call may be routed to any location in the world from a single telephone number.

It is also an object of the present invention to provide a system that includes a computer that is connected to the Internet and a standard telephone company switch such that the computer may directly communicate with the Internet and the standard telephone company switch.

It is also an object of the present invention to provide a system whereby a person may register for a telephone number account on the system through a remote computer connected to the Internet.

It is also an object of the present invention to provide a database on the computer that will be used to store telephone account information.

It is also an object of the present invention to provide a system whereby the computer may be programmed and maintained by a remote computer connected to the Internet.

It is also an object of the present invention to provide a system whereby the telephone company switch initiates a direct connection to the computer when an outside telephone call is directed toward a telephone account previously stored in the database on the computer.

It is also an object of the present invention to provide a system whereby when an outside call is directed toward the computer, the outside caller can choose from a menu of pre-programmed locations of where to direct the call.

It is also an object of the present invention to enable a person to choose from a list of pre-programmed telephone numbers that may subsequently be assigned to that person.

It is also an object of the present invention to provide a system whereby a person may program the computer to automatically forward incoming telephone calls from his or her assigned telephone number to a pre-determined telephone number that is dependent upon the time and day of the year.

It is also an object of the present invention to provide a system whereby the computer maintains a call history log in the database.

It is also an object of the present invention to provide a system whereby an incoming caller may store voice messages on the computer that are later remotely accessible from a person via the Internet.

It is also an object of the present invention to provide a system whereby at a predetermined time the computer will automatically call a pre-programmed telephone number with a pre-programmed voice message.

It is also an object of the present invention to provide a system whereby a person may remotely program the computer to enable a custom or standard greeting to be played when an incoming call is made to the pre-determined telephone number.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a diagram of the integrated system of connections between the Internet, the telephone company switch, and a computer that connects the Internet and telephone company switch.

### DESCRIPTION OF PREFERRED EMBODIMENTS

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

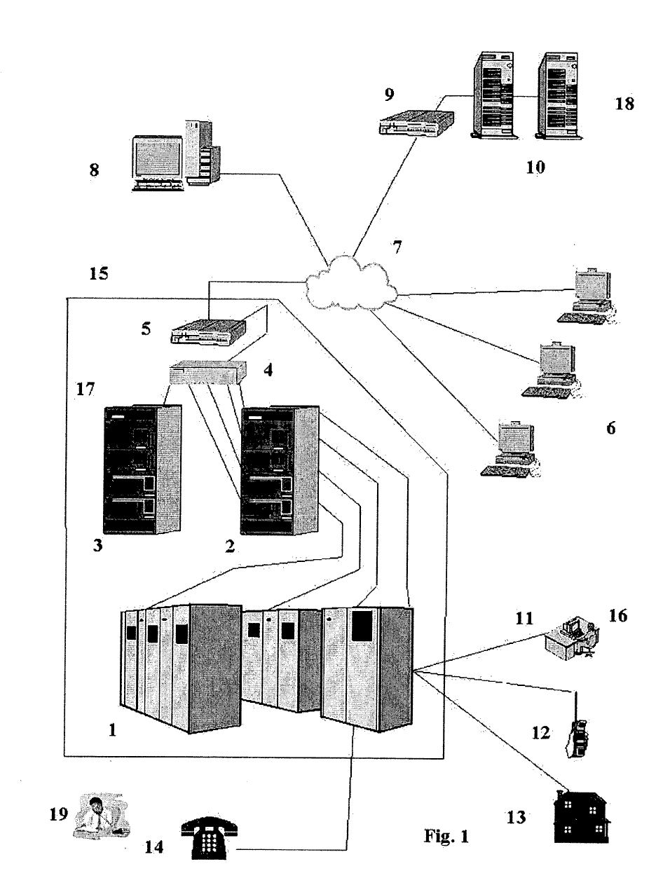

FIG. 1 displays an integrated system for transmitting telecommunications information showing a telephone company switch 1. The switch 1 is normally located in a central office 15. A large city may have several central office 15 locations. The central office 15 is generally where most telephone calls are routed to other their destination subsequent to origination such as an office phone 11, a cellular or mobile phone 12, or a home phone 13. These telephone calls usually originate from a standard telephone 14, but may originate from any number of devices such as cellular phones, facsimile machines or modems. The standard telephone 14 is connected electronically to the switch 1.

A telephony server 2 is connected directly to the switch 1 such that it may communicate directly with the switch electronically. A database server computer 3 is connected to the telephony server 2. This connection may be made through a network hub 4, or they may be directly connected to each other. It is also possible to use a single computer that may act as both a telephony server 2 and a database server 3.

The database server 3, like most computers contain a storage medium such as a hard disk. The hard disk in the database server 3 contains a database of information 17 that at a minimum will include available telephone numbers that would initially be flagged as inactive telephone numbers, personal data such as name and address of a registrant 16, telephone numbers where the registrant 16 may be reached, schedule information of the registrant 16, and voice and audio data of callers who will try to contact the registrant. It is also well known in the art that other forms of information may reside in a standard database on a storage medium in a database server 3.

The network hub 4 is connected to an Internet Firewall 5 through a Virtual Private Network (VPN) 5. The Internet Firewall may consist of a software program that protects from unwanted access to the database server 3 or telephony server 2. The Internet Firewall 5 is connected to the Internet 7 via standard Internet connection hardware.

The telephony server 2 and database server 3 may be accessed remotely by connecting a remote management computer 8 to the Internet 7. The remote management computer 8 may be provided a secure connection to the telephony server 2 and database server 3 through a password or other layer of protection through the Internet 7. A web server 10 serves as a host to a software user interface 18 that is connected to the Internet 7 through a VPN 9.

The present invention provides a unique system and method for a registrant 16 to acquire or register for a unique local telephone number whereby any incoming calls to the registrant's 16 unique local telephone number may be routed to any telephone number in the world. This is accomplished in the following manner. Initially, a registrant 16 may access the Internet 7 through standard home or business computers 6 to register and obtain a unique local telephone number. This is accomplished by using a computer 6 to connect to a software interface 18 stored on the web server 10. Once a connection is made to the software interface 18 on the web server 10 through the VPN 9, the web server 10 connects to, and accesses the database server 3 to determine what local telephone numbers are available to be assigned to the registrant 16 in the database 17. The database server 3 transmits any available local numbers back to the software interface 18 stored on the web server 10 through the VPN 9. This information is then transmitted from the web server 10 to the computer 6. Upon receipt at the computer 6, the registrant 16 through the software interface 18 enters his personal information such as his name, home and/or business address and then chooses from a list of available local telephone numbers that hereinafter shall be referred to as “Bphone” numbers, thereby activating a new account for the registrant 16. The registrant 16, then may enter a wealth of information into the software interface 18 from the computer 6 such as a list of telephone numbers where the registrant 16 may be reached, the times and locations when the registrant 16 may be reached at the respective telephone numbers, and a personal or standard greeting. This information is then transmitted from computer 6 through the Internet 7 to the web server 10 through the VPN 9. This information is then relayed through the VPN 9 over the Internet 7 through the Internet Firewall 5 and is stored in the database 17 on the database server 3.

Once the registrant 16 has received his new Bphone number, the Bphone number is available to receive incoming telephone calls from standard telecommunications devices such as the telephone 14. When a call is made from an incoming caller 19 to the local vicinity of the central office 15, the switch 1 receives the incoming call. The switch 1 connects to the telephony server 2 to determine whether the incoming call is intended for either an inactive Bphone number stored on the database server 3, an active Bphone number stored on the database server 3, or an entirely different telephone number issued through the local telephone company. If the incoming call is to be directed to a telephone number issued by the telephone company, the switch 1 simply routes the telephone call electronically to its destination. If however, the incoming call is to be directed to an inactive or active Bphone number stored on the database server 3, the telephony server 2 will access the database on the database server 3 to determine whether the destination telephone number is an active or inactive telephone number. If the Bphone number is inactive, the telephony server 2 will play a pre-recorded message to the incoming caller through the switch 1 to the standard telephone 14 indicating that the Bphone number dialed is considered inactive. If however, the telephony server 2 accesses the database server 3 and determines that the Bphone number is an active Bphone number, the telephony server 2 will first determine the current time and check the database server 3 to determine whether the registrant 16 has a preset location and telephone number where he or she can be reached. If a preset time and location can be determined, the telephony server 2 will direct the switch 1 to route the incoming call from the standard telephone 14 through the switch 1 to the preset telephone number such as the registrant's 16 office 11, cellular phone 12, or home phone 13. The telephony server 2 then disconnects from the switch 1 and enables a standard connection through the switch 1 to be continued for an indefinite period of time. If the registrant 16 is not available at any of the pre-determined locations or simply does not answer the incoming call, the telephony server 2 will request that the incoming caller 19 leave a voice message through the telephone 14. The voice message is then recorded on the telephony server 2 in electronic form and stored in the database server 3. This voice message may be retrieved by the registrant 16 by accessing the software interface at the web server 10 from computer 6 through the Internet 7.

If the telephony server 2 accesses the database server 3 and determines that a preset time and location cannot be determined, the telephony server 2 accesses the database server 3 and determines the list of telephone numbers already stored in the database that corresponds to the registrant's 16 account information on the database server 3. This information is then transmitted to the telephony server 2 whereby the telephony server 2 will play a standard pre-recorded audio message that will give the incoming caller 19 the ability to select from a menu of options that will enable the incoming caller 19 to reach the registrant 16 at any one of the telephone numbers corresponding to the registrant's 16 account stored on the database server 3 such as his or her's office phone 11, cellular phone 12, or home number 13. Once the incoming caller 19 chooses the destination telephone number, the telephony server 2 will direct the switch 1 to route the incoming call from the telephone 14 to the destination telephone number such as the office phone 11, cellular phone 12, or home number 13. The telephony server 2 then disconnects from the switch 1 and enables a standard connection through the switch 1 to be continued for an indefinite period of time. It is well known in the prior art that the destination telephone numbers may be any available telephone number throughout the entire world. If the registrant 16 is not available at any of the predetermined locations or simply does not answer the incoming call, the telephony server 2 will request that the incoming caller 19 leave a voice message through the telephone 14. The voice message is then recorded on the telephony server in electronic form and stored in the database server 3. This voice message may be retrieved by the registrant 16 by accessing the software interface at the web server 10 from computer 6 through the Internet 7.

Every incoming call that is made to a Bphone number is logged in the database on the database server 3 so that, like the stored voice messages, they may later be retrieved by the registrant 16 by accessing the software interface at the web server 10 from computer 6 through the Internet 7.

The telephony server 2 also constantly accesses the database server 3 to determine if the registrant's 16 account was preset to call the individual at a specific time and/or location. If the telephony server 2 determines that a preset time condition has been reached, the telephony server 2 accesses the database server 3 and determines the telephone number and location where the registrant 16 may be reached and routes a prerecorded message and telephone call through the switch 1 to the preset telephone number and location such as the registrant's 16 office telephone 11, cellular telephone 12, or home telephone 13.

The web server 10, the telephony server 2, and the database server 3 may be maintained and remotely managed from the remote management computer 8 through a password-protected secure connection through the Internet 7 so that it would not be necessary to have a technician physically travel to the central office 15 or to the location where the web server 10 is physically located. It is also possible that a single server computer may act as a database server 3, telephony server 2, and a web server 10 if necessary.

What is claimed is:

1. A system for routing incoming telephone calls to a desired location comprising:
A. A switch,
B. at least one first external telecommunications device, said at least one first external telecommunications device capable of emitting at telecommunications signal, said telecommunications signal containing an external telephone number,
C. at least one second external telecommunications device, said at least one second external telecommunications device capable of receiving said telecommunications signal,
i. said switch being capable of receiving and externally routing said incoming telecommunications signal to said at least one second external telecommunications device,
ii. said switch being electronically communicative to said first external telecommunications device,
iii. said switch being electronically communicative with said at least one second telecommunications device,
D. at least one external computer,
E. at least one local computer,
i. said at least one local computer further comprising:
a) a database, said database capable of indexing data in electronic form, said database including,
(1) at least one first telephone number,
(2) at least one routing telephone number,
ii. said at least one local computer being electronically connected to said switch,
F. a global computer network,
i. said at least one local computer being electronically connected to said global computer network,
ii. said at least one external computer being electronically connected to said global computer network such that said at least one local computer may communicate electronically with said at least one external computer via said global computer network,
G. whereupon said switch capable of receiving said at least one incoming telecommunications signal from said first external telecommunications device said switch communicates electronically with said local computer to determine if the external telephone number in said incoming telecommunications signal is identical to said at least one first telephone number stored in said database, and if said first and external telephone numbers are identical, said local computer communicates electronically to said switch to route said incoming telecommunications signal from said first external telecommunications device to said at least one second external telecommunications device at said at least one routing telephone number, until said incoming telecommunications signal ceases to exist.

2. The device in claim 1 wherein upon said at least one second external telecommunications device receives said incoming telecommunications signal from said first external telecommunications device, the electronic connection between said local computer and said switch terminates.

3. The device in claim 1 wherein a remote management computer is connected to said global computer network such that said remote management computer may communicate electronically with said local computer via the global computer network.

4. The device in claim 1 wherein a web server computer is connected to said global computer network such that said software interface program is stored in said web server computer such that said at least one external computer may communicate electronically with said web server computer such that when data is entered into said web server computer using said software interface program, said data may be transmitted and stored in said database via said global computer network.

5. The device in claims 3 and 4 wherein said remote management computer may communicate electronically with said web server computer via said global computer network.

6. The device in claim 1 wherein a log history of electronic transmissions of said incoming telecommunications signals may be stored on said database on said local computer, said log history being accessible from said at least one external computer through said global computer network.

7. The device in claim 1 wherein said local computer periodically accesses said database, said database containing a preprogrammed condition and a preprogrammed audio message in electronic form, such that when said preprogrammed condition has been met, said local computer will access said database and transmit and route said audio message in electronic form to said at least one second telecommunications device through said switch.

8. The device in claim 1 wherein said connection between said local computer and said switch terminates upon delivery of said telecommunications signal to said at least one external telecommunications device from said switch.

9. The device in claim 1 wherein the switch is preprogrammed with a second database stored in said switch such that the second database contains a set of at least one third telephone numbers that are identical to the at least one first telephone numbers such that when the switch receives the incoming telecommunications signal, said switch determines if the external telephone number is not identical to one of the set of at least one third telephone numbers, the switch will not route said incoming telecommunications signal to said at least one second external telecommunications device.

10. A method of routing a telecommunications signal comprising the steps of:
A. programming at least one first telephone number and at least one second telephone number into a database on a local computer,
B. programming a predetermined audio message on said local computer,
C. initiating a telephone call from a telecommunications device whereby after dialing a destination telephone number, said telecommunications device transmits the destination telephone number electronically to a switch, said switch being electronically connected to said local computer,
D. transmitting said destination telephone number electronically to said computer whereby said local computer determines if said first telephone number is identical to said destination telephone number,
i. if said at least one first telephone number is identical to said destination telephone number, said local computer accesses said at least one second telephone number electronically from said database on said local computer and sends an electronic signal to said switch that enables said switch to route said telephone call to said at least one second telephone number until said telephone call is terminated, upon receipt of said telephone call by said at least one second telephone number, the electronic connection between said local computer and said switch terminates.
ii. if said at least one first telephone number is not identical to said destination telephone number, said local computer accesses said predetermined audio message, and said local computer sending the predetermined audio message in electronic form from said computer through said switch to said telecommunications device.

11. The method in claim 10 further comprising the step of connecting said local to a global computer network such that the at least one first telephone number may be added to said database on said local computer from at least one external computer that is connected to said global computer network.

12. The method in claim 10 whereby a person is given exclusive privileges to obtain said at least one first telephone number from at least one external computer that is connected to said global computer network.
